(19) United States
(12) Patent Application Publication
(10) Pub. No.: US 2002/0101932 A1
(43) Pub. Date: Aug. 1, 2002

(54) Method and apparatus for encoding information using multiple passes and decoding in a single pass

(76) Inventor: Dennis L. Montgomery, Reno, NV (US)

Correspondence Address: Pillsbury madison & Sutro LLP, Ninth Floor, East Tower, 1100 New York Avenue, N.W., Washington, DC, 20005-3918, US

(21) Appl. No.: 09/727,096

(22) Filed: Nov. 29, 2000

(51) Int. Cl. G06K 9/36

(52) U.S. Cl. 375/240.25; 382/244

(57) ABSTRACT

The present invention describes a method of and apparatus for operating upon digital data by which the digital data is partitioned into a plurality of blocks, a plurality of threads are created, such that each thread includes at least one of the plurality of blocks, and thereafter each of the threads are operated upon to obtain a plurality of compressed threads, each compressed thread including at least one compressed block of digital data. In this method, the threads are operated upon using a compression engine such that a compression algorithm repeatedly, a cyclical manner, compresses data that in a previous pass was already compressed by the compression engine. Between each of the compression passes, the then compressed data is operated upon using metadata established in the previous pass to eliminate redundancies that exist in the data compressed in the previous pass. Accordingly, the present invention compress digital data using multiple passes of a predetermined compression algorithm to obtain compressed digital data, and subsequently compress the compressed digital data using a single pass of a corresponding decompression algorithm to obtain the digital data in a lossless process.

### FIELD OF THE ART

The present invention method and apparatus for encoding and decoding information, and more particularly to a method of encoding using multiple passes and decoding in a single pass.

### BACKGROUND OF THE RELATED ART

With the prevalence of computers and electronic transmissions, methods of compression and decompression of digital information are in widespread use.

One parameter that affects the requirements of the system is the speed with which the compression needs to take place. In certain systems that operate upon information in real-time, the compression must take place at a rate that is faster than the real-time rate. In other systems that allow for the compression to be performed off-line, the compression process can take place off-line.

Another parameter is the amount of compression that is required. Whereas a text file may be small, and require no compression before being transmitted or stored, an image file can become quite large, such that transmission or storage in a memory or a disk of the uncompressed image becomes prohibitively expensive.

Furthermore, the rate at which the compressed information is decompressed is another parameter that can be considered in determining the type of compression used. While it may not be an issue to spend an entire second decompressing a single still image, if a sequence of images must be decompressed so that playback at real-time rates can occur, the rate at which the decompression takes place can become a significant factor.

Conventional compression/decompression systems balance the above and other parameters in a variety of manners. The compression algorithm used in certain systems, for instance, may be determined by the importance of obtaining the most compression on the digital information, irrespective of the time taken to compress it. Certain other systems offer various degrees of compression, and will use a different compression algorithm accordingly.

Despite the vast number of different compression/decompression systems that exist, there is continually a need for such a system that operates more efficiently. A conventional manner of obtaining more efficiency is to develop more efficient compression/decompression algorithms. While this has significant advantages, development of usable algorithms can be a costly and risky undertaking.

A common characteristic of conventional compression/decompression systems is that as digital information is received for compression, that digital information is operated upon in the sequence it is received. Thus, compression of a first received slice of bits will occur, and compression of the subsequently received slice will occur only after the first received slice has been compressed. This can be viewed as compression that occurs in a single pass, since each slice of data is only operated upon a single time, and once operated upon, will not be operated upon again.

Even if multiple processors are used to operate upon consecutive slices, the overall compression rate is limited to the slice that is slowest to compress, and essentially the system is still a single pass system. Accordingly, if a particular slice cannot be compressed, the compression operation will fail.

Accordingly, methods and apparatus that can more effectively compress and decompress compressed digital data are needed.

### SUMMARY OF THE INVENTION

It is an object of the present invention to more effectively and losslessly compress digital data and decompress compressed digital data.

It is another object of the present invention to adaptively predict a probable period of time that it will take for compression encoding of digital data, and to use those predictions in determining the compression encoding to use.

It is another object of the present invention to partition digital data into multiple threads, and independently operate upon the multiple threads in order to effectuate a desired amount of compression.

It is another object of the present invention to partition digital data into multiple threads, and independently operate upon the multiple threads in order to effectuate a desired amount of compression within a given period of time.

It is a further object of the present invention to operate upon digital data in a sequence of passes, thus improving the resulting compression.

It is yet a further object of the present invention decode previously compressed data in a single pass.

The above objects, among others, singly or in combination, are achieved by the present which describes a method of and apparatus for operating upon digital data by which the digital data is partitioned into a plurality of blocks, a plurality of threads are created, such that each thread includes at least one of the plurality of blocks, and thereafter each of the threads are operated upon to obtain a plurality of compressed threads, each compressed thread including at least one compressed block of digital data.

In this method, the threads are operated upon using a compression engine such that a compression algorithm repeatedly, a cyclical manner, compresses data that in a previous pass was already compressed by the compression engine. Between each of the compression passes, the then compressed data is operated upon using metadata established in the previous pass to eliminate redundancies that exist in the data compressed in the previous pass.

Accordingly, the present invention compress digital data using multiple passes of a predetermined compression algorithm to obtain compressed digital data, and subsequently compress the compressed digital data using a single pass of a corresponding decompression algorithm to obtain the digital data in a lossless process.

### BRIEF DESCRIPTION OF THE DRAWINGS

The above and other objects, features, and advantages of the present invention are further described in the detailed description which follows, with reference to the drawings by way of non-limiting exemplary embodiments of the present invention, wherein like reference numerals represent similar parts of the present invention throughout several views and wherein:

FIGS. 1A and 1B illustrates an exemplary portion of digital data containing different file types that can be operated upon and metadata, respectively, according to the present invention;

FIG. 2 illustrates a block diagram of the compression/decompression system according to the present invention;

FIG. 3A illustrates a flow chart of initial interface controller operation during compression according to the present invention;

FIG. 3B illustrates a flow chart of the compression engine operation during compression according to the present invention;

FIGS. 4A-4D illustrate graphically the effects of the compression operation on digital data according to the present invention at various times during the compression operation;

FIGS. 5A-5 illustrate graphically the creation of compressed data and metadata during the compression of digital data at various times during the compression operation.

### DETAILED DESCRIPTION OF THE PREFERRED EMBODIMENTS

Initially, aspects of the present invention relating specifically to compression and decompression will be discussed. Thereafter, other aspects of the present invention will be noted.

With respect to compression and decompression, to put the present invention in context, the format of the digital data being operated on will first be discussed. An advantageous features of the present invention is that it has the ability to operate upon, and potentially compress, either previously uncompressed data, such as a text file or an image file, as well as previously compressed data, such as an MPEG file or a ZIP file. Put another way, the present invention can operate upon recognized file types, as well as unrecognized file types. In the Windows® operating system environment, each file has a header portion that defines that particular file type. As a result, in most instances the files that a user will operate upon in recognizable format. The same is true for other operating systems, such as Unix, MAC, Linux and others. Of course, it is known that various operating systems share many of the same file types. Accordingly, while there are hundreds and hundreds of such file types, most are recognizable by the definition provided in the header portion.

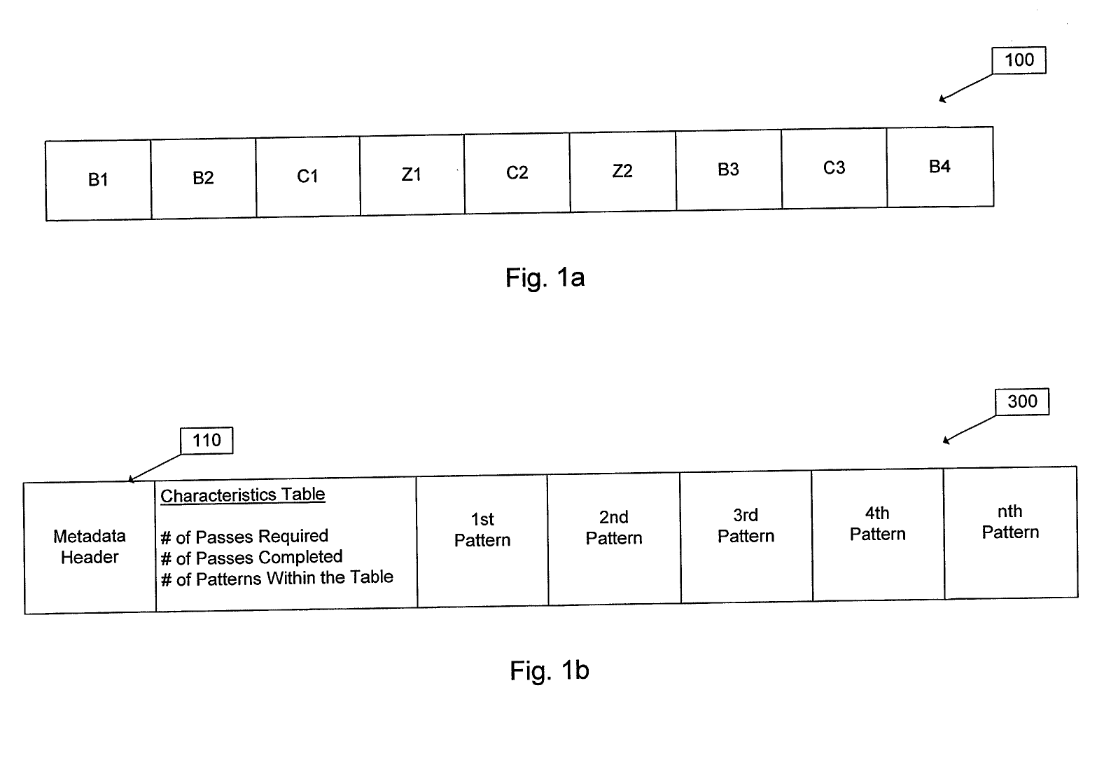

FIG. 1 illustrates an exemplary portion of digital data 100 containing many different types of files that can be operated upon using the present invention. For ease of explanation, only three file types are shown, bitmap files B, executable files C, and zip files Z. As will be apparent, bitmap files B are uncompressed files, executable files C are program files, and zip files Z are compressed files. This exemplary portion of digital data 100 may be data that needs to be stored on a memory device of some sort, for example such as a semiconductor memory, a hard disk drive, or a CD, could be data that needs to be transmitted along a transmission path of some sort, or may have some other need to be compressed or further compressed. While the exemplary portion shows different file types, it is understood that the present invention can also operate upon data that is of a single file type -and in fact certain advantages will become apparent if it operates upon such data, as described hereinafter.

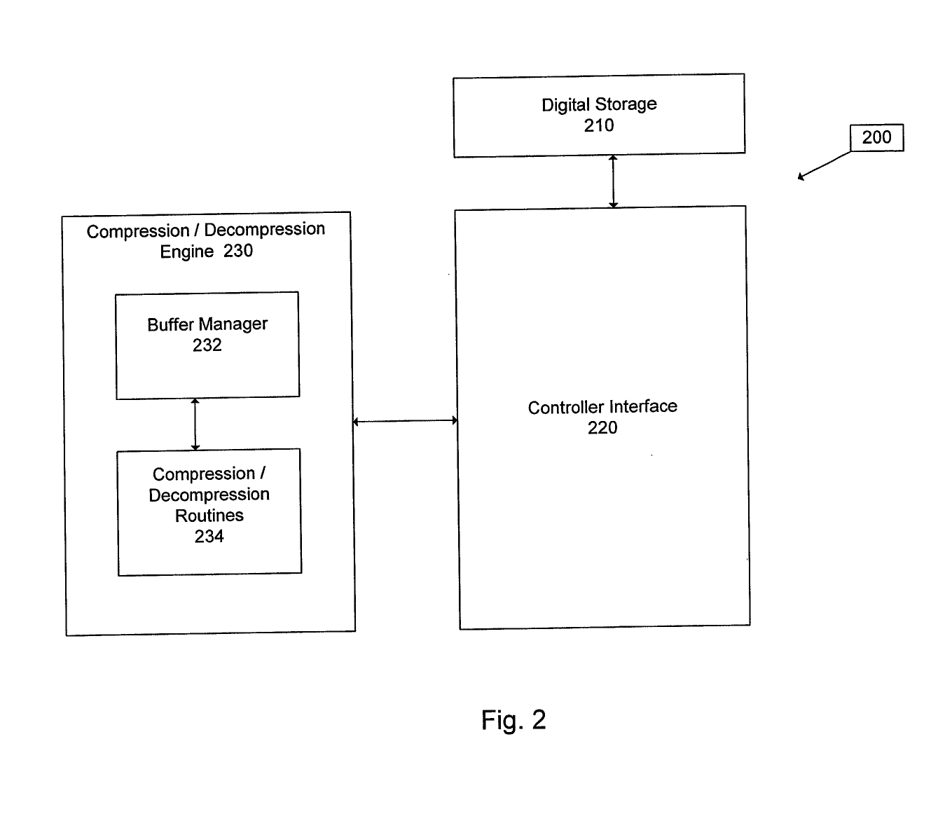

FIG. 2 illustrates a system 200 that operates upon digital data 100. For purposes of this example, it is assumed that the digital data is stored in digital storage 210, and that this digital data requires compression. For purposes of this discussion the system 200 will be described as re-storing the digital data 100 as compressed digital data 100′ back to the digital storage 210 once it is compressed. An explanation of the decoding of the compressed digital data 100′ will then be provided. It is understood, however, that once the compressed digital data 100′ is obtained, that it can be stored or transmitted in a variety of manners for subsequent use. Certain specific manners in which compressed digital data 100′ can be used will be described hereinafter, but those described manners are not intended as being limiting.

In addition to the digital storage 210, FIG. 2 illustrates that the system 200 contains a controller interface 220 and a compression/decompression engine 230. While each of these parts of the system 200 will be described with respect to each other, it is understood that each part, and the corresponding functions implemented by each part, have unique aspects. While the controller interface 220 and the C/D engine 230

may time-share and use the same microprocessor, in a preferred embodiment of the invention a different processor is used to implement each, with the C/D engine 230 being implemented using at least one processor that has the capability of operating upon multiple threads simultaneously. Still further, a number of different processors in parallel can be used to even more efficiently implement the C/D engine 230, as will be described hereinafter. No matter which of the implementations are used, the controller interface 220 and the C/D engine 230 are preferably implemented as a sequence of program instructions, written in C++ or some other computer language, or, alternatively, implemented in hardware. It has been found particularly advantageous to implement the C/D engine 230 in a DSP, such as a Texas Instruments TMS 320 DSPs that are offered in the C5X, C6X and C7X series models, which each offer various price-performance trade-offs with respect to each other, but effectively allow the compression and decompression algorithms to run at speeds that are much faster than would be possible if those algorithms required execution by the same microprocessor controlling the controller interface 230.

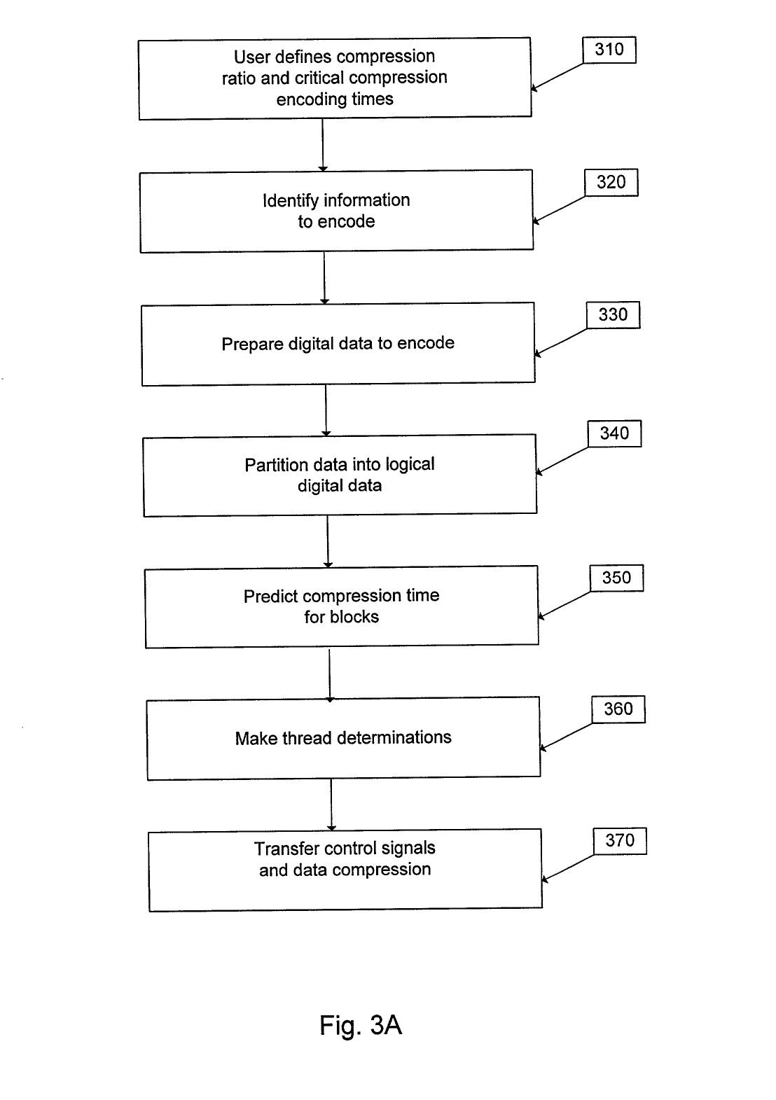

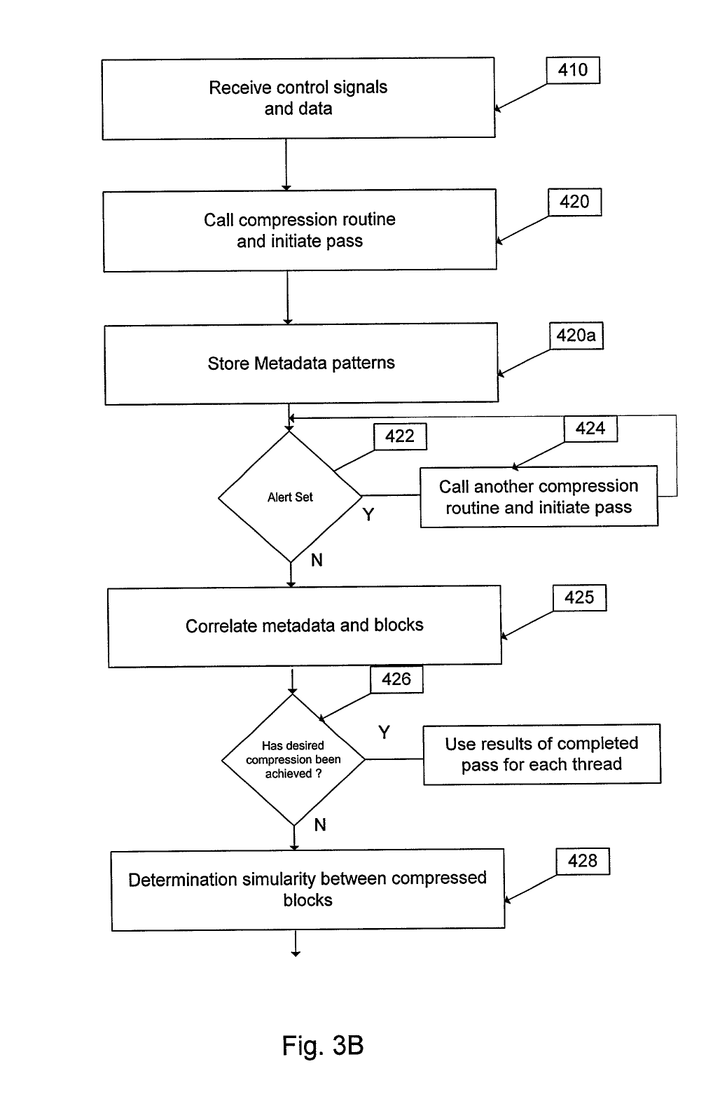

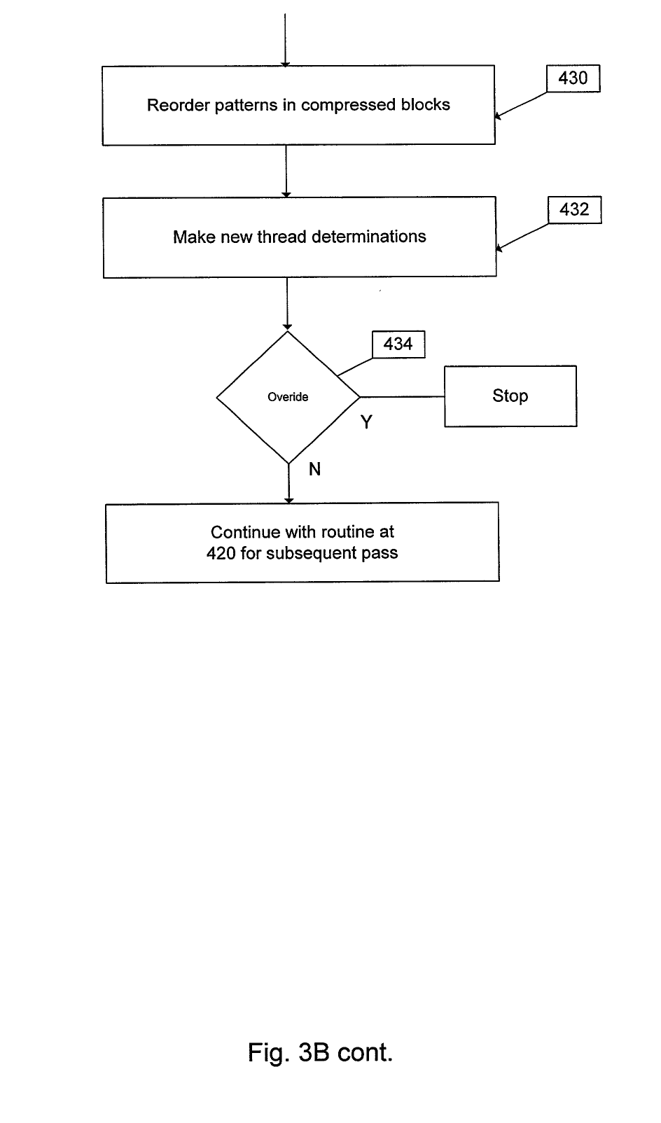

The compression of digital data 100 by operation of the system 200 will now be described with reference to FIG. 3. Initially, as shown by step 310, the user will define desired compression ratios and critical compression encoding times. While these will vary, depending on the user application, in general it will be appreciated that the higher the compression ratios and the shorter the encoding times needed, the more the system 200 will have to work to ensure that the desired ratios and times can be met. And it should be noted that although certain ratios and times are desired, there is not certainty that the system 200 will in fact be able to meet those requirements. In this regard, it is further noted that the specific type of compression (and corresponding decompression) routines that are used are not the focus of the present invention. Rather, an aspect of the present invention is the ability, for a set of defined compression routines, to adaptively predict a probable period of time that it will take for compression encoding the entire amount of digital data 100 to the level of compression required based upon various compression routines, and to use those predictions in determining the compression routine to use, as will be described hereinafter. Accordingly, the starting point for making these predictions is indicating to the system 200 the desired compression ratios and encoding times.

These compression ratios and encoding times can be predicted for different types of digital information. Table I below provides an exemplar of compression ratios obtainable for different types of files and compression routines, depending upon how many passes are made on the digital information in the file, for files that are of generally the same size. Typically, compression will increase as the more passes are made, although the amount of compression that is achieved will lessen over time, generally in an exponentially, or at least faster than linearly, decreasing manner. It is assumed that the digital information is operated upon using compression routines that are known, such as LZW, or others, but which are enhanced by the capture of metadata 300, as will be described hereinafter.

After the user inputs the desired compression ratios and compression encoding times, step 320 follows and the controller interface 220 from FIG. 2 identifies the digital information 100 to encode. Manners of identifying such information and causing one device (such as the memory 210) to recognize and pass the information to another device (such as the controller interface are well known and need not be further described. Once identified by the controller interface 220, the header 110 that is associated with each file within the digital information 100 is recognized by the controller interface 220, and the header information used to detect the file type, and file size.

Based upon this information, the controller interface will then, in step 330, prepare the digital data 100 for compression encoding.

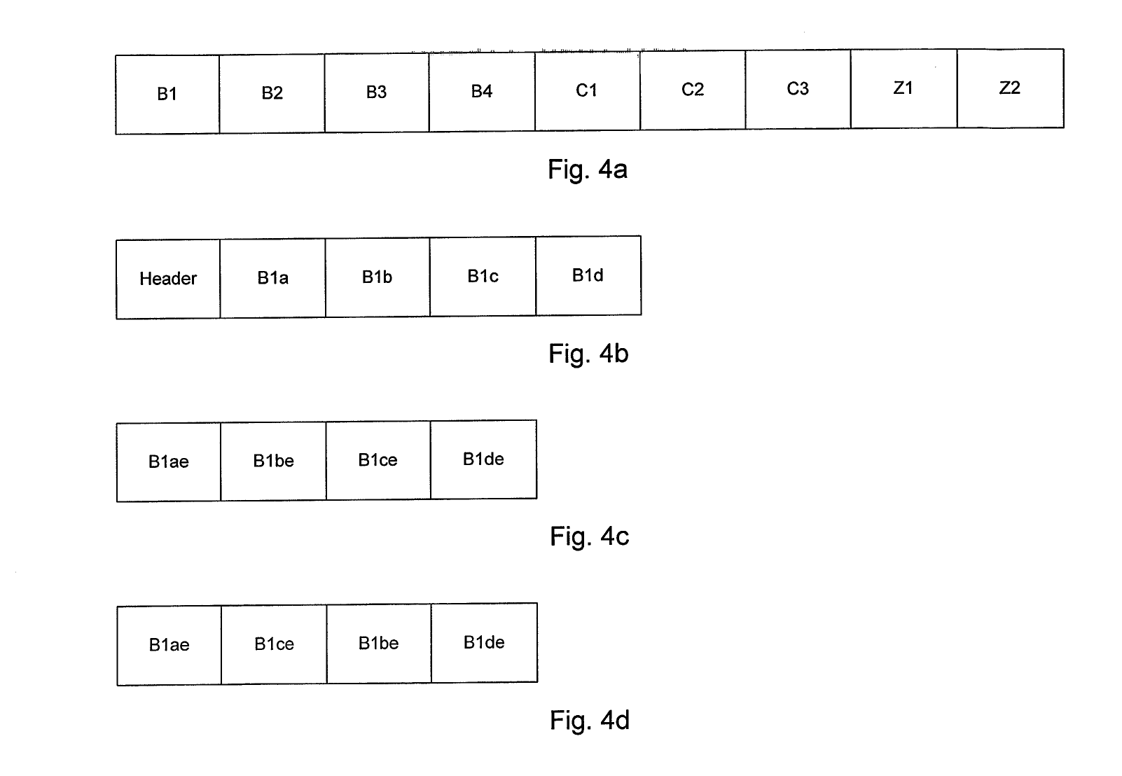

FIGS. 4A-4E illustrate graphically the effects of the compression operation on digital data according to the present invention at various times during the compression operation. In FIG. 4A, there is depicted the original digital information file 100, but in an order in which files that have some relative similarity have been grouped together (which in the example shown results in the same order). As an overall level example, image, program, and compressed files could each be grouped with other image, program and compressed files. Preferably, however, since there are many different types of image files, program files, and compressed files, each type of file (as identified in the header of each file) is grouped relative to each other. Thus, as shown in the specific example of FIG. 4A, there are bitmap B files, executable C files and zip Z files. It should be understood, however, that the present invention can operate on and attempt to compress files of any type, and is not limited to those specifically used in this example, with the exception of files that the system 200 has already compressed.

It is understood that the data that corresponds to each of these files is preferably not physically moved to new memory locations (although theoretically this would be possible), but that pointers are created to associate an order to the individual files based upon file type. This is also true for the explanations provided hereinafter where data is shown as being moved, since visually it is more easily understood when described in this manner.

The user can determine the granularity of the grouping. Thus, as preferably described above, there is a grouping for each file type. There could, alternatively be subject matter groupings for similar file types, such as the image, program and compressed files. Further, some other manner of making groupings from 1 to N, (where N is any integer that is less than the maximum number of files types and greater than one) can be implemented, such as using an adaptively predicted amount that the file could be compressed (as described hereinafter), in which case the initial group 1 files are those that are predicted to compress the most, whereas the group N files are those that are predicted to compress the least. Alternatively, this grouping could be determined by the adaptively predicted time that will be needed for compression, in which case group 1 files are those that are predicted to compress the fastest, whereas the group N files are those that are predicted to compress the slowest.

This grouping is performed so that files predicted to contain data that are estimated as having similar compression characteristics will be relatively similar to compress are associated with each other. This allows more efficient compression, and allows, at subsequent stages in the compression process described hereinafter, disguised redundancies to become more easily apparent.

Further, after the initial grouping, there occurs, as shown in step 340, partitioning of the digital data, typically on a per file basis, into blocks, as shown in FIG. 4B by the partition of file B1 into the header portion, and then portions B1a, B1b, B1c, and B1d is performed. This partition is preferably made so that, for the type of file, each block has a size that is optimized for a size that can most easily be compressed. The size of the blocks will vary widely, and will typically be within a range of 0 to 65K bytes.

Once the blocking is performed in step 340, step 350 follows and the interface controller 220 operates upon each block to adaptively predict a probable period of time that will be required to compress each of the blocks for each of the files that make up the digital information 100 in order to achieve an overall desired compression ratio using a specific compression routine. Based upon the header information, and knowledge gained from having previously compression encoded files of a similar type, an estimate is obtained of a probable period of time that it will take for compression encoding of each block of the entire amount of digital data 100 to the level of compression required based upon the specific compression routine, which estimates are then accumulated to predict the total.

All of the blocks of a particular file type are estimated as being the same for the same relative block size based upon the file type from the header. In this regard, a Table can be used that provides the estimated amount of compression and estimated time it will take to achieve that compression using a specific compression routine for each file type. It is apparent from Table I provided below that for each different file type, the amount of compression will generally increase the greater the number of passes that are used.

TABLE 1A
Example File Type Choices

| File Type | Extension | Category |
|---|---|---|
| Image | .bmp | B |
| Executables | .exe | D |
| Compressed | .zip | Y |

TABLE 1B
Example of File Type With Predicated Ratios

| Category | Passes (Ratio) | Passes (Ratio) | Passes (Ratio) |
|---|---|---|---|
| B | 1 (2.0:1) | 2 (3.0:1) | 4 (4.0:1) |
| D | 1 (2.0:1) | 2 (2.5:1) | 4 (3.0:1) |
| Y | 1 (1.2:1) | 2 (1.4:1) | 4 (1.5:1) |

TABLE IC
Example of File Type With Predicated Times

| Category | Passes (Ratio) | Encoding Time | Passes (Ratio) | Encoding Time | Passes (Ratio) |
|---|---|---|---|---|---|
| B | 1 (2.0:1) | 100 msec | 2 (3.0:1) | 200 msec | 4 (4.0:1) |
| D | 1 (2.0:1) | 100 msec | 2 (2.5:1) | 200 msec | 4 (3.0:1) |
| Y | 1 (1.2:1) | 100 msec | 2 (1.4:1) | 200 msec | 4 (1.5:1) |

Based upon estimates of how much that data of that type typically compresses when using that specific compression routine, estimates of amount of compression needed, and the number of passes estimated to get to that level of compression, an estimated time required to achieve that level of compression can be obtained. Accordingly, in order to compress all of the digital information 100, different compression routines, as well as how many passes to make using the same compression routine, as described hereinafter, can be used. Interface controller 220 can decide which to suggest using for each different block in order to attempt to achieve the overall desired compression. For example, for a file, say Z1 in FIG. 1, that will typically only slightly compress after the first pass using a given compression routine, (as illustrated in Table I above), interface controller 220 may suggest that the C/D engine only make 1 pass on the blocks for the Z1 file, but for other files, such as B1 and B2 from FIG. 1, may suggest 2 and 3 passes, respectively, as being appropriate for the compression routine suggested so that the desired compression for those blocks can be achieved, in order to attempt to arrive at the desired compression in the desired period of time for the entire amount of digital information 100.

It is also noted that while the interface controller 220 makes these initial predictions and transmits control signals and metadata related to these initial predictions, along with the data to be operated upon, to the C/D engine 230 as described further hereinafter, and while the C/D engine 230 will initially use these control signals and metadata when operating on the particular block, the C/D engine 230 can independently determine to deviate from the operations suggested by the control signals and metadata, as well be discussed further hereinafter.

With respect to the creation of control signals and metadata, another aspect of the present invention relating to the concept of using different threads for the compression of different data will be provided. A different thread may be determined as being needed for each block in a file, or a number of files all may use the same thread. How this determination is made will be explained hereinafter. With respect to the consideration of whether to implement a new thread, it is again noted that the interface controller 220 has made predictions as to the expected duration required for the compression of each block using a specific compression routine. Another way of looking at this is the interface controller 220 will estimate the number of encoding passes that the routine may make on each block, for that compression routine. Accordingly, if there is a certain block that interface controller 220 has predicted will be difficult to compress, then a separate thread can be identified, with that thread having associated with it unique metadata as well as control signals, that provide the information necessary for the C/D engine 230 to begin the compression routine operation on that thread. Accordingly, for each block that interface controller 220 has determined should be independently compressed, a separate thread will be created.

Since the present invention can operate independently on each block if needed, although in many instances it will operate on many blocks with a single thread, the interface controller needs to be able to determine when to create a new thread or when to use the same thread for multiple blocks, as shown by step 360 in FIG. 3. For instance, if the time needed to compress a block of data is greater than some threshold value, then a new thread is created for that block is created by the interface controller 220. If not, then another block is added to the previous block, such that a string of blocks will be tagged for being compressed via the same thread by the interface controller 220.

In light of the above, it will be appreciated that the interface controller 220 will generate to the C/D engine 230 control signals indicating which compression routine it suggests running for each thread. While the interface controller also generates other routine handshaking signals to ensure that data is properly transferred, those need not be described. Certain diagnostic control signals that are generated will be discussed hereinafter as appropriate.

Further, the metadata that is generated provides characteristics of the compression routine, as well as significant patterns that may be associated with the type of stream that is being operated upon. The metadata organization is illustrated in FIG. 1B. With respect to metadata characteristics of the compression routine, there are three that are of significance:

1. the Passes Required variable which indicates to the C/D engine the number of passes that the interface controller predicts will be required to be made in order to achieve the desired amount of compression, as described above;

2. the Passes Completed variable which is blank when being sent to the C/D engine, but which the C/D engine will pass to the interface controller so that it can update its predication table; and

3. the Patterns Within variable which provides the number of patterns which follow within the metadata. Initially, there will typically be no patterns. After the first pass of the stream that is operated upon by the compression routine, patterns that are found within the data are obtained and will be used, as described further herein. These patterns are saved within the metadata.

With the above explanation being made, once the thread determination step 360 is complete, step 370 begins, the appropriate control signals, metadata, and threads of data are transmitted to the C/D engine 230, so that the compression of each of the blocks within a give thread can take place.

FIG. 3B illustrates the various steps that the C/D engine 230 takes when it receives a request from the interface controller 220 to perform a compression routine on a particular thread. As shown by step 410, the C/D engine 230 receives the initial control signals, metadata and corresponding data blocks from the interface controller 220 and will store the associated metadata and data blocks in a memory of a buffer manager 232, illustrated in FIG. 2. Buffer manager 232 operates as a data manager, since it will also store interim operation results, as described hereinafter, as well as the final compression results which will ultimately be returned to the interface controller.

Step 420 follows, and show that the processor associated with the C/D 230 engine uses the compression routine control signal to call the appropriate compression routine, and initiate the execution of the first pass of the compression routine.

So that this first pass is more clearly understood, a discussion of the compression routines illustrated in the FIG. 2 compression/decompression routines block 234 will be described. Compression/decompression routines block 234 will contain many different compression and their corresponding decompression routines, so that there exist compression/decompression routines for each file type, and preferably redundant compression/decompression routines for file types and other compression/decompression routines as they may become available. Each compression/decompression routine is typically comprised of compression and decompression algorithms, which are preferably written in a compilable programming language such as C++, as well as tables of compression/decompression data associated therewith, as are known, although other compression/decompression routines can be used. As mentioned above, since the specific compression/decompression routines that are used are not considered as being within the scope of this invention, further discussion of such routines is unnecessary.

Once a block is encoded using a certain compression routine after the first pass, the encoded information will not contain any fully-redundant patterns. In a conventional system, accordingly, compression would be complete at this point, and if further compression were needed, it would be necessary to restart the compression process with a different compression routine. In the present invention, however, partially-redundant patterns of compressed already data are obtained, and then stored as patterns in metadata, as discussed herein, and these patterns can then be used to alter the compressed sequence, prior to the re-compressing in a second pass of a previously compressed block, as will be described further hereinafter.

During initiation of the compression routine 420, the time that the compression routine takes is tracked, and is stored in a diagnostic memory portion of the buffer manager 232. If the time that the routine takes to successfully execute is greater than some predetermined period of time, an alert will be set, as shown by step 422, thereby indicating to the C/E engine to either use different tables of compression data that are associated with the same compression routine, or use a different compression routine altogether. The alert can also be set if the routine successfully executes within the desired period of time, but the compression achieved is outside the predicted range by some percentage, such as 5 of 10% greater than that predicted.

Reasons that the compression may take longer or not compress as much are many. For instance, the header file type may be mislabeled such that the data associated therewith exhibits characteristics different than those that were anticipated, or the data within a block may exhibit different characteristics purely based on the data being different than expected.

If it is determined that another compression routine is needed, as shown by step 422, the step 424 follows and the compression routine is changed based upon an evaluation of the pattern of the bits that are within block being operated upon. Since different file types typically have distinct patterns, the evaluation can recognize patterns based on having previous knowledge of distinct patterns associated with various file types. which patterns can be stored in some type of table or the like.

After the completion of the first pass of the compression routine in step 422, on the initial block or blocks, results, which may be interim, are obtained, and stored in buffer manager 232. These interim results are illustrated in FIG. 4C, which provides an example of the compression of a bitmap file B1 shown in FIG. 4A,which, as shown in FIG. 4B was partitioned, as discussed above, into four blocks B1a, B1b, B1c, and B1d. Assuming that all the blocks in this file were made a single thread by the interface controller 220 as described above, then the resulting output at the end of the first pass by the compression routine will be four corresponding compressed blocks B1ae, B1be, B1ce, and B1de.

During this first pass, however, as shown by step 420A, the compression routine will store in the buffer manager memory copies of patterns that are found within the blocks that are being operated upon, such as the four blocks B1a, B1b, B1c, and B1d in the example being discussed. While the bit length of patterns can vary, it is preferable to use a bit length of between 3 and 8 bits, and most preferably 6, since any smaller length patterns will not provide any further compression, and larger bit lengths will result in less patterns that have redundancies, or partial redundancies. It should also be noted that the file type can be used to determine the types of patterns stored. For instance, for uncompressed image files, where many redundancies can be expected, the number of patterns stored is typically less than when storing patterns from an already compressed file, since the number of redundant patterns in an already compressed file is already minimal.

At the point in which a pattern is detected, it is stored into a metadata file such as illustrated in FIG. 1B, and the Patterns Within characteristics field is updated to reflect the addition of each pattern. In step 420A, the compression routine will find a and then copy a pattern based upon its being similar. Whether a pattern is similar can be based upon the characteristics of patterns in files of that type, the degree to which the patterns are random, and comparisons with other patterns that are stored for other blocks that have been previously operated upon.

Since, when applying the above criteria, at the first pass there will potentially exist many different patterns, some of which typically are partially redundant. This metadata will be then used for the subsequent pass, as hereinafter described.

At the end of this pass, the compression routine will perform a number of operations. Also, as shown by step 425, the metadata associated with each thread is correlated to the blocks from which the metadata was created.

Further, the C/D engine determines, as shown by step 426, whether the compression that needs to be achieved has been achieved. This determination is performed by tracking the compression of each the different threads, and determining that further compression is needed. In this regard, since different threads will begin and end at different times, it is understood that this is an ongoing process that occurs with the completion of each thread. Once the desired overall amount of compression required is achieved, the pass of the compression process ongoing for each of the other threads can be completed, or the current pass can be terminated and the results of the completed pass used, as shown by step 427.

If, as shown by step 428, compression of the compressed block is determined to continue, the compression routine then reviews the compressed blocks within a given thread to determine similarities that exist among the encoded blocks, and then in step 430 reorders the blocks so that blocks containing similar patterns are adjacent to each other. In step 428 determining whether similarities exist, the compression routine preferably uses a number of comparison functions (add, subtract, multiply, divide, XOR, AND and other such functions) to determine if there is partial overlap of patterns that have been stored in the metadata. In finding patterns that are the same or similar, tree traversal operations of GET equal to, GET greater than or equal to, or GET less than or equal to are used.

In this regard, since each of the patterns stored in the metadata are in a tree structure, such that the patterns can all be identified by a corresponding number, typically binary, which then allows the tree structure to be easily traversed using the various tree traversal operations, patterns that have a partial overlap can be identified and then operated upon with a comparison function. Thus, if one pattern in an encoded block was “0101”, it is assumed that after the first pass of the compression routine, that this same pattern will not exist, since such a redundancy would have been eliminated. However, the pattern “0100” may exist, and it is apparent that this pattern differs from the pattern “0101” by a single bit. Thus, step 428 determines that these patterns are related, and step 430 then allows the reordering of the patterns by indicating with pointers that the pattern “0100” exists as being offset from the pattern “0101” by a length of so many bits, and that the pattern “0100 ” can instead be represented by the pattern “0101,” minus “1.” Thus, the encoded stream will then be changed to reflect this partial overlap in the pattern and eliminate it. Furthermore, once these operations are performed for all of the previously compressed blocks in a stream, and then either that stream, a subset of it, or a superset of it is sent to the compression routine again for a subsequent compression pass that is made by the compression routine, even further compression can be achieved since the patterns within the blocks of the stream being compressed again is now different than that pattern which had previously resulted from the first pass compression.

It should also be noted that between passes, the type of comparison operation that is used can be changed, in an adaptive manner. More specifically, the adaptive determination of the comparison operation is made based upon the pattern of the compressed blocks as compared to representative file type patterns, which representative file type patterns can also be stored in a table on the system, as has been described.

Continuing with the example provided, it may be determine that blocks B1ae and B1ce have similarities, and that blocks B1be and B1de have similarities, and thus reorder the blocks in that manner, as shown in FIG. 4D.

In performing the determination and reordering steps, each of the threads that were created in the first pass will be stripped from the corresponding compressed blocks, and corresponding diagnostic signals, as mentioned above, will be sent to the interface controller indicating that each previously created thread has been terminated. It is also noted that in this portion of the second or subsequent pass of compression, that the metadata used corresponds to metadata created for each block within the thread of a previous pass. Thus, in the example provided, since the metadata from the threads of B1ae, B1be, B1ce and B1de was all from the same thread, then the same metadata will be used on the B1ae/B1ce thread, and the B1be/B1de thread. It is understood, however, that if the blocks were combined from what was previously two separate threads, then the metadata from each of the two separate threads will be combined, and used in this operation. This latter implementation, however, adds another layer of complexity to an already complex system, and accordingly is not, at the present time, the preferred implementation.

Once reordered, the compression engine then determines how many new threads to implement in step 432 based on the characteristics of the reordered data, and signals will be sent to the interface controller identifying each newly created thread. Accordingly, in the example discussed above, since it was determined that blocks B1ae and B1ce have similarities, and that blocks B1be and B1de have similarities, the compression routine may decide to implement each of these as a separate thread. Thus, each of these two threads will be operated upon, preferably independently, for further compression as separate threads.

The compression operation on the previously compressed data that has then been further manipulated by usage of the metadata and reordering as described above then continues, as described previously in the discussion of step 420 and thereafter. It should be noted, however, that if compression continues because the amount of compression desired has not yet been achieved, a manual override, shown as step 434, can terminate the process if, after repeated passes, further compression is not occurring. This termination can also be automatic, such that if the desired compression is not achieved after some integer number N passes, the process terminates.

At the conclusion of the second pass, the steps which occurred after the first pass, as described above, are again repeated for each thread on which compression was further performed, and the process then continues with that repetition until either it is complete, a determination is made that completion to the desired compression is not possible, or time has run out (which is essentially the same as achieving the desired compression was not possible).

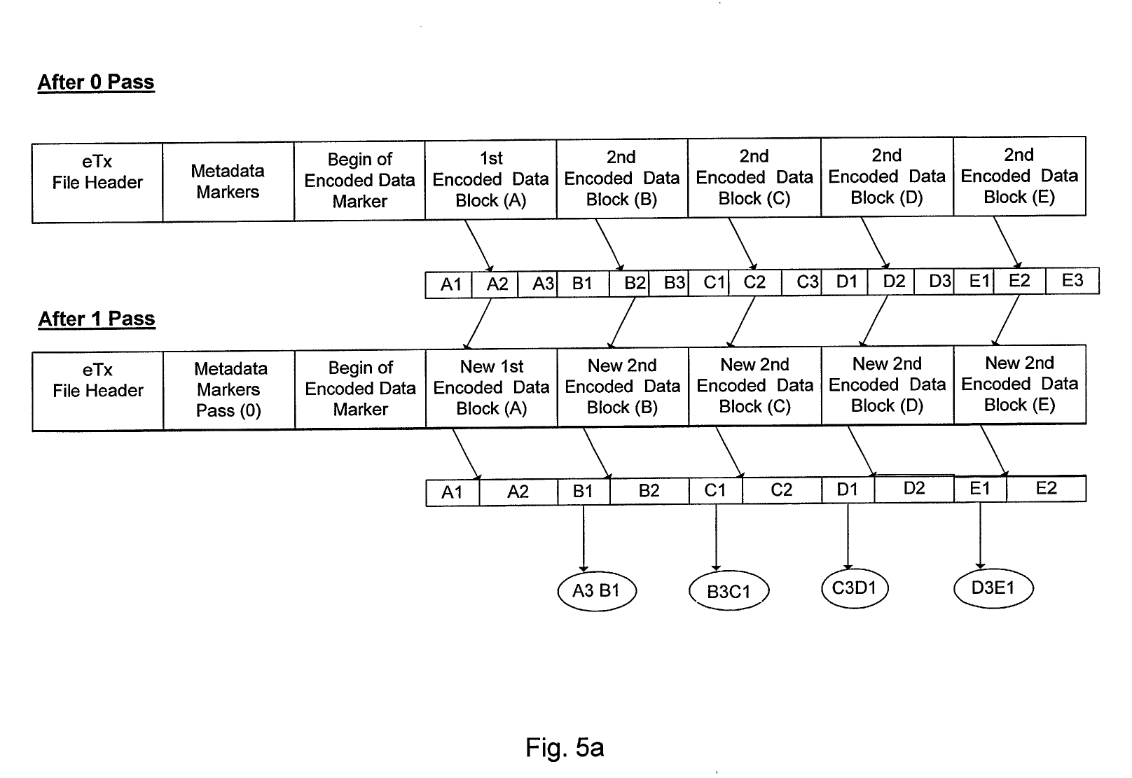

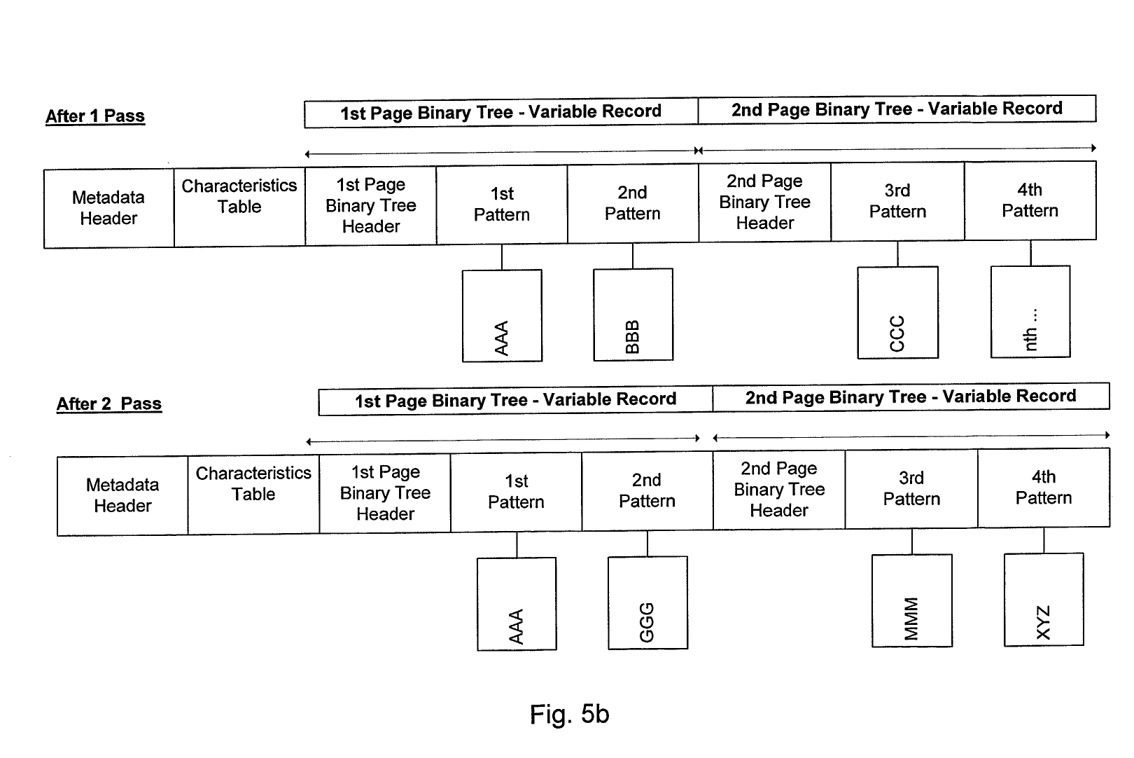

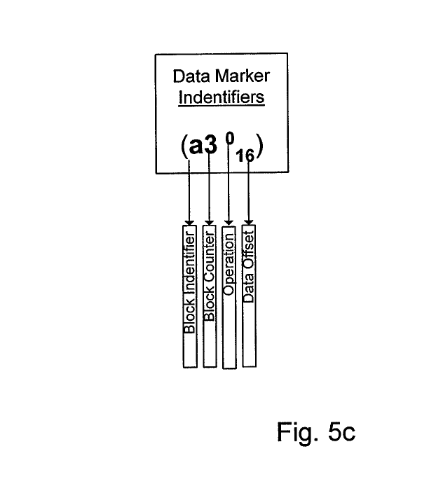

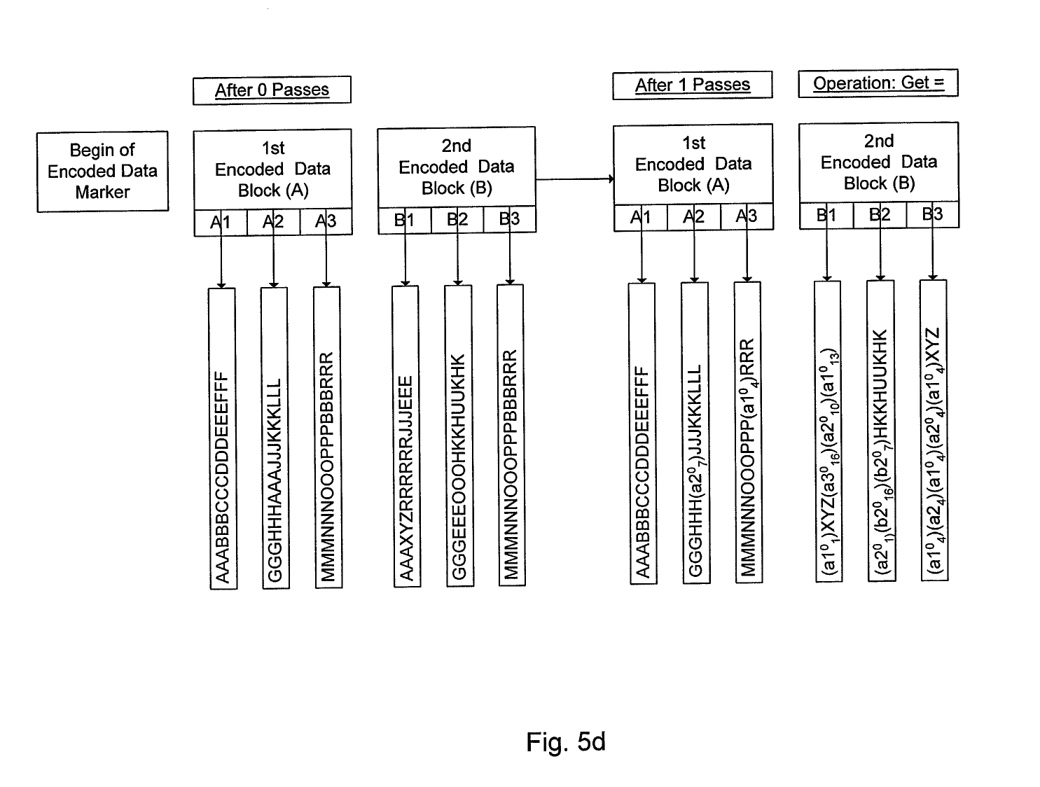

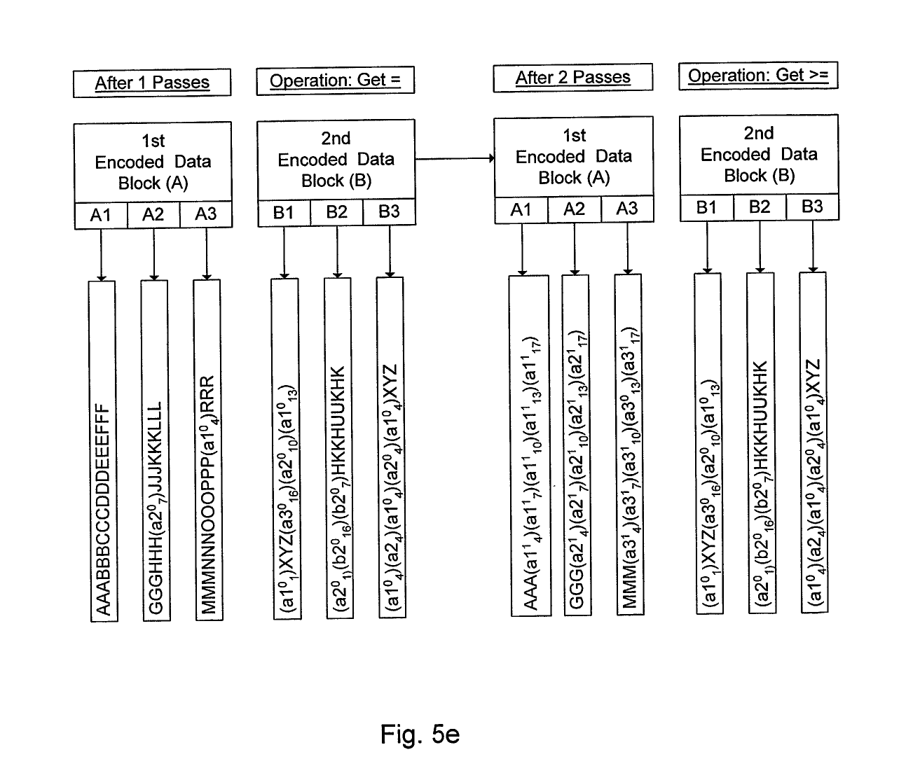

Third, fourth and fifth passes are also possible, with the metadata that is partially overlapping becoming successively smaller with each subsequent pass, as will become apparent hereinafter with respect to the discussion of FIGS. 5A-5E. Accordingly, at the end of the process, the remaining metadata will preferably be saved.

It is noted that metadata obtained from one compression operation, and particularly metadata that exists after three, four or five passes have been made, can be saved in that state, and then used as metadata in another compression operation, even with an entirely different compression system, and included as information used during the first pass compression operation for that another compression operation. This will enhance the speed of the another compression operation due to the existence of the metadata that would not otherwise be available, since the patterns in the metadata that exist after those passes are indicative of more subtle redundancies or partial redundancies that are not otherwise easily apparent.

At the end of a successful compression routine for a stream of data, a series of compressed blocks will result, which the buffer manager 232 will then transmit back to the interface controller 232.

In the process described above, as will be illustrated hereinafter in more detail with respect to FIGS. 5A-5E, after some number of passes, one, two, ten or more, the data will become compressed to some amount, and further compression according to the present invention will then become difficult to achieve. Accordingly, at such point the data can be considered compressed as much as possible, and can then be transmitted, stored, or otherwise used as desired in that compressed form. At some time, however, decompression will occur. According to the present invention, as will become apparent from FIGS. 5A-5E, the decompression operation is a reciprocal operation, since the operations performed in decompression mirror those that were performed during compression. Thus, the decompression algorithm is an inverse of the compression algorithm, and the other operations performed, as described above, can similarly be transposed. One significant difference between the compression and decompression operations, however, is that while the compression operation may well take multiple passes to compress, the decompression operation can always occur in a single pass. This is because each pass of the compression operation operates using the same compression algorithm that operates upon the encoded data, as described above, and the entirety of the original data stream can be derived finally compressed data. In contrast, conventional compression techniques that use multiple passes to compress will require multiple passes to decompress because such techniques will go back and use the source data, rather than the compressed data, when making another pass.

A sample operation using a simplified sample data set will now be described with reference to FIGS. 5A-5E to illustrate both the multiple pass compression, as well as the ability to decompress. It should be noted that in this example, upper case alphabetic characters are used as the set of data elements, and that an “A” has a value that is one less than that of a “B”. This simplification has been introduced in order to allow a more concise explanation to be provided, but in no way should be interpreted as limiting the type of data on which the present invention operates and can compress and decompress. Further, the data as shown when describing the tree traversal and comparison function operations which are based upon metadata is considered as having been compressed by the compression engine, even it will be apparent that a compression engine would not, for instance, leave a pattern AAA in an uncompressed form.

As illustrated, FIG. 5A illustrates an example of digital data from a single file that has had previously determined metadata markers with the information previously described with reference to FIG. 1B inserted, and potentially actual metadata from a different compression event, which will be usable during first pass compression, as described above. For the following example, however, it is assumed that the there are no metadata patterns in the metadata marker portion before the first pass.

Each of the encoded blocks A-E can be subdivided into blocks themselves, such as shown by in the “AFTER 0 Pass” portion of FIG. 5A with block A being subdivided into blocks A1, A2 and A3, initially by the interface controller 230 as described above. As shown, the blocks A1-E3 have been grouped in a single thread. After completion of the first pass compression by the compression engine 232, and removal of the threads associated with the first pass compression, the file structure is then as shown in the “AFTER 1 Pass” portion of FIG. 5A. Thereafter, the encoded data is operated upon as described above prior to initiation of the second pass. As shown, the blocks A1, A2, B1, B2 . . . are identified by label as being the same, but it should be understood that they have been further compressed. Further, the block B1 has been formed by combining what were previously blocks A3 and B1, as shown by A3B1 in the oval disposed below and associated with block B1.

FIG. 5B illustrates the metadata associated with the compression, at each pass. As noted above, since in the first pass it was assumed that there were no metadata patterns, metadata patterns from before the first pass are not illustrated. In the “AFTER 1 Pass ” metadata, illustrated are metadata patterns AAA, BBB, CCC . . . It is noted that the pattern length in this example is thus three, and not some greater number as noted above. These metadata correspond to the patterns that were found in the first sub-block A1 of block A of the data after 0 Passes illustrated in FIG. 5D. Since each of the patterns AAA, BBB and CCC are not similar to each other, each have been identified as a separate metadata pattern.

Referring now to FIG. 5D, the first and second encoded blocks A and B, after having been operated after the first pass, and with a GET=traversal function and an=comparison function the first and second encoded data structure appears as shown. It is noted that for simplicity sake in these examples, since only an equal to comparison function is used, that this comparison function is not illustrated by an identifier, but that in practice, the comparison function used must be stored within the other data associated with the pattern being operated upon. As shown, the encoded data sub-block A1 is left alone, since none of the patterns equal any of the other patterns. However, in the sub-block A2, the AAA pattern is represented as (a2⁰₇) with, as shown in FIG. 5C, the various identifiers being the block identifier, the block counter, the operation, and the data offset. Thus, in this example, the “a” represents that the data was from block A, the “2” represents that the data was from the second sub-block, the “0” represents the Get=to traversal operation, and the “7” represents the bit position of the first character for the pattern. The other patterns shown thereafter are illustrated with this same nomenclature to show these similarities.

FIG. 5E illustrates the data from the transition between the After 1 Pass using a GET=to tree traversal operation to after the second pass in which a GET>=tree traversal operation is used. As shown, since BBB differs from AAA by one, the BBB pattern becomes (a1¹₄), with the “a” represents that the data was from block A, the “1” represents that the data was from the first sub-block, the “1” represents the Get>=to traversal operation, and the “4 ” represents the bit position of the fourth character for the pattern. The other patterns shown thereafter are illustrated with this same nomenclature to show these similarities.

Referring again to FIG. 5B, it is also noted that the metadata for After Pass 2 has changed, since after this pass the remaining available metadata patterns are AAA, GGG, MMM, HKK, HUU, KHK, and XYZ. It should be noted, however, that AAA is not metadata in the sense that it will be found again, but since it is the pattern to which the other patterns relate, it is kept.

Specific applications of the compression/decompression system described above are numerous. In order to appreciate the scope of the present invention, a few examples will be provided.

1. Compression/decompression of a digital movie (compression time insensitive, decompression time very sensitive)

2. Compression/decompression of various files on disc drive (amount of compression very sensitive, compression and decompression time sensitive).

3. Compression/decompression of a real-time video feed for distribution on the Internet (compression time very sensitive, decompression time very sensitive).

While the present invention has been described herein with reference to particular embodiments thereof, a latitude of modification, various changes and substitutions are intended in the foregoing disclosure. For instance, whereas the present invention has been described for sake of clarity in terms of the interface controller and the C/D engine being separate components (which is preferred) it is still within the scope of the present invention that the operations and functions described herein can be adapted so that their equivalents are performed by either a single processor or by even further multiples of the processors. It will thus be appreciated some features of the invention will be employed without a corresponding use of other features, and that other modifications can be made, without departing from the spirit and scope of the invention as set forth in the appended claims.

I claim:

1. A method of operating upon digital data comprising the steps of:
partitioning the digital data into a plurality of blocks;
creating a plurality of first threads, such that each first thread includes at least one of the plurality of blocks; and
operating upon each of the plurality of first threads to obtain a plurality of compressed first threads, each compressed first thread including at least one compressed block of digital data.

2. A method according to claim 1 wherein the step of operating upon each of the first threads performs lossless compression.

3. A method according to claim 1 wherein the step of operating upon each of the first threads independently operates upon each of the plurality of first threads.

4. A method according to claim 1 wherein at least certain ones of the first threads are independently operated upon in parallel.

5. A method according to claim 4 wherein, during the step of operating, at least two different compression algorithms are used to independently operate upon different first threads.

6. A method according to claim 1 further comprising the step of combining the plurality of compressed first threads to obtain digitally compressed data.

7. A method according to claim 1 wherein the step of creating the plurality of first threads includes the step of associating each of the plurality of blocks of digital data with one of the plurality of first threads such that blocks within each of the plurality of first threads share certain common compression characteristics.

8. A method according to claim 7 further including the step of predicting an estimated compression time and estimated compression amount for each block.

9. A method according to claim 8 wherein the step of creating the plurality of first threads also uses estimated compression time and estimated compression amount to determine which blocks should be associated with the same first thread.

10. A method according to claim 8 wherein the estimated compression time and estimated compression amount are made based upon a selected compression algorithm, and wherein the step of predicting includes the step of determining whether a proposed estimated completion time that is based upon one of the compression algorithms available for selection will allow for a desired compression amount to be achieved within a desired compression time for the digital data.

11. A method according to claim 1 wherein the step of creating each of the plurality of first threads uses a data type of each of the plurality of blocks so that each of the first threads contains blocks which have a similar data type.

12. A method according to claim 11 wherein the data type is determined according to header information related to each block.

13. A method according to claim 11 where the data type is determined by comparing the block data to various predetermined data patterns.

14. A method according to claim 1 further including the step of predicting an estimated compression time and estimated compression amount for each block.

15. A method according to claim 14 wherein the step of creating the plurality of first threads uses estimated compression time and estimated compression amount to determine which blocks should be associated with the same first thread.

16. A method according to claim 1 wherein the step of partitioning data includes the step of determining a size of each of the plurality of blocks taking data type of each block into account.

17. A method according to claim 1 further including the steps of:
operating upon each of the compressed first threads to eliminate each of the compressed first threads and retain the compressed first blocks;
creating a plurality of second threads, such that each second thread includes at least one of the plurality of compressed first blocks; and
operating upon each of the plurality of second threads to obtain a plurality of compressed second threads, each compressed second thread including at least one compressed second block of digital data.

18. A method according to claim 17 wherein the step of operating upon each of the second threads independently operates upon each of the plurality of second threads.

19. A method according to claim 17 wherein at least certain ones of the second threads are independently operated upon in parallel.

20. A method according to claim 17 wherein, during the step of operating upon each of the plurality of second threads, the same compression algorithm used to operate upon each block is also used to operate upon the corresponding compressed block.

21. A method according to claim 17 further comprising the step of combining the plurality of compressed second threads to obtain digitally compressed data.

22. A method according to claim 17 wherein the step of creating the plurality of second threads includes the step of associating each of the plurality of compressed first blocks with one of the plurality of second threads such that compressed first blocks within each of the plurality of second threads share certain common compression characteristics.

23. A method according to claim 22 wherein each of the second threads contains compressed first blocks that were created from the same first thread.

24. A method according to claim 23 wherein the number of second threads is greater than the number of first threads.

25. A method according to claim 22 wherein compressed first blocks that were within the one of the first threads are used to form two distinct second threads.

26.. A method according to claim 17 wherein the step of operating upon each of the plurality of first threads also results in obtaining a plurality of first metadata sets, each first metadata set including portions of compressed first blocks which are determined to possibly have redundancies disposed therein.

27. A method according to claim 26 wherein the step of operating upon each of the first threads will maintain for each thread a pattern of data in an initial compressed first block that corresponds to a first metadata pattern, each of the different first metadata patterns for each first thread combining to result in the first metadata set for that first thread.

28. A method according to claim 27 wherein the pattern of data in the initial compressed first block is maintained during subsequent steps.

29. A method according to claim 17 wherein each first thread has an associated first metadata set.

30. A method according to claim 26 wherein the step of creating the plurality of second threads includes the steps of:
determining which compressed first blocks should be associated with the same second thread; and
using the first metadata sets to eliminate redundancies in some of the compressed first blocks associated with at least some of the second threads.

31. A method according to claim 30 wherein the step of operating upon each of the plurality of second threads also results in obtaining a plurality of second metadata sets, each second metadata set including portions of compressed second blocks which are determined to possibly have redundancies disposed therein.

32. A method according to claim 31 wherein the second metadata set is a subset of the first metadata set.

33. A method according to claim 26 wherein:
the step of operating upon each of the first threads will maintain for each thread a pattern of data in an initial compressed first block that corresponds to a first metadata pattern, each of the different first metadata patterns for each first thread combining to result in the first metadata set for that first thread;
the step of using the first metadata sets to eliminate redundancies in some of the compressed first blocks associated with at least some of the second threads maintains the pattern of data in the initial compressed first block and eliminates the pattern of data in a subsequently compressed first block.

34. A method according to claim 33 wherein, during the step of using the first metadata sets to eliminate redundancies in some of the compressed first blocks associated with at least some of the second threads, the pattern of data in the subsequently compressed first block is replaced with a pointer and an operation designator, thereby obtaining a plurality of compressed and reduced first blocks in each second thread.

35. A method according to claim 34 wherein, during the step of operating upon each of the plurality of second threads, the same compression algorithm used to operate upon each block is also used to operate upon the corresponding compressed and reduced first block to thereby obtain the compressed second blocks.

36. A method according to claim 35 wherein the operation designator identifies an operation used to eliminate redundancies in the first compressed data blocks, the operation being one of an equal to comparison operation, a greater than or equal to comparison, and a less than or equal to comparison.

37. A method according to claim 36 wherein, during the step of operating upon each of the plurality of second threads, the comparison operation selected is adaptively determined.

38. A method according to claim 37 wherein the adaptive determination is made based upon the pattern of the compressed blocks as compared to representative file type patterns.

39. A method of operating upon digital data comprising the steps of:
compressing the digital data using multiple passes of a predetermined compression algorithm to obtain compressed digital data; and
decompressing the compressed digital data using a single pass of a corresponding decompression algorithm to obtain the digital data.

40. An apparatus for operating upon digital data comprising the steps of:
means for compressing the digital data using multiple passes of a predetermined compression algorithm to obtain compressed digital data; and
means for decompressing the compressed digital data using a single pass of a corresponding decompression algorithm to obtain the digital data.

41. An apparatus according to claim 40 wherein the means for compressing includes:
an interface controller; and
a compression engine.

42. An apparatus according to claim 41 wherein the search engine comprises a single central processing unit.

43. An apparatus according to claim 41 wherein the search engine comprises a plurality of central processing units.

44. An apparatus according to claim 43 wherein each of the plurality of central processing units operate upon different threads.

45. An apparatus according to claim 44 wherein the plurality of central processing units comprise a plurality of digital signal processors.

46. A method of allowing a plurality of compression systems to operate more efficiently comprising the steps of:
obtaining metadata representative of patterns in first digital data obtained from the compression of the first digital data in a first compression system; and
distributing the metadata to the at least a second compression system so that the second compression system can use the metadata to compress second digital data which the second compression system needs to compress.
